(19) United States
(12) Patent Application Publication
(10) Pub. No.: US 2005/0052838 A1
(43) Pub. Date: Mar. 10, 2005

(54) Portable device and rotating and positioning mechanism thereof

(76) Inventor: Chun-Liang Yeh, Taipei City (TW)

Correspondence Address: RABIN & Berdo, PC, 1101 14TH STREET, NW, SUITE 500, WASHINGTON, DC, 20005, US

(21) Appl. No.: 10/878,115

(22) Filed: Jun. 29, 2004

(30) Foreign Application Priority Data
Sep. 4, 2003 (TW) 92124430

(51) Int. Cl. G06F 1/16

(52) U.S. Cl. 361/683

(57) ABSTRACT

A portable device and a rotating and positioning mechanism thereof. The rotating and positioning mechanism includes a first body, a second body, and a sliding member. The second body has a rotational shaft, rotatably disposed along the rotational shaft with respect to the first body. The sliding member is slidably disposed on the rotational shaft and disposed in the first body. When the second body rotates to a predetermined angle, the sliding member engages the second body, thereby securing the second body to the first body.

### BACKGROUND OF THE INVENTION

1. Field of the Invention

The present invention relates to a rotating and positioning mechanism, and in particular to a rotating and positioning mechanism for a portable device such as a notebook computer.

2. Description of the Related Art

FIG. 1 is a schematic view of a conventional notebook computer. A notebook computer 100 comprises a display 120 and a body 110. The notebook computer 100 is closed by engaging a hook 121 on the display 120 with a groove 111 on the body 110. Pressing a button 122 on the display 120, releases the engagement between the hook 121 and groove 111, thereby opening the notebook computer 100.

Although functional, the conventional locking device with hook and groove limits the design possibilities for the appearance of notebook computers. Hence, there is a need for a modified notebook computer locking device.

### SUMMARY OF THE INVENTION

Thus, an object of the invention is to provide a rotating and positioning mechanism without requiring hooks for use in a notebook computer or other electronic product.

The present invention provides a portable device and a rotating and positioning mechanism thereof. The rotating and positioning mechanism includes a sliding member, slidably disposed on a rotational shaft, rotating with respect to a first body and a second body. When the second body rotates with respect to the first body to a predetermined angle, the sliding member engages the second body, thereby securing the second body to the first body.

The present invention further provides a portable device, including a first body, a hinge, and a second body. The hinge has a sliding member, slidably disposed on a rotational shaft, rotating with respect to a first body. The second body is disposed on the hinge. The second body has a display thereon, rotatably disposed along the rotational shaft with respect to the first body. When the second body is rotated to a predetermined angle, the sliding member engages the second body, thereby securing the second body to the first body.

The rotating and positioning mechanism of the present invention is an internal engaging device, rather than the conventional external locking device. The appearance of the notebook computer is thus not limited by the conventional device. By pressing the sliding member of the rotating and positioning mechanism, the engagement is easily released, opening the computer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional notebook computer;

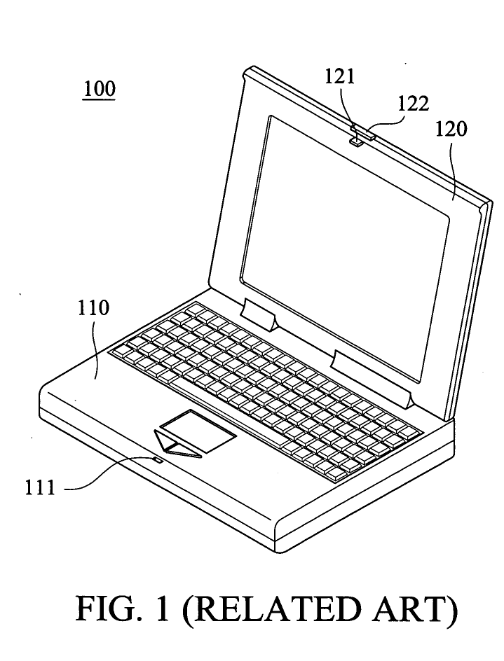

FIG. 2 is a schematic view of the notebook computer according to the present invention;

FIG. 3A is an exploded view of a rotating and positioning mechanism of the notebook computer according to the present invention;

FIG. 3B is a schematic view of the rotating and positioning mechanism of the notebook computer according to the present invention at a first position;

FIG. 4 is a schematic view of the rotating and positioning mechanism of the notebook computer according to the present invention at a second position; and

FIG. 5 is a schematic and installed view of the sliding member and the first body of the rotating and positioning mechanism of the notebook computer according to the present invention.

### DETAILED DESCRIPTION OF THE INVENTION

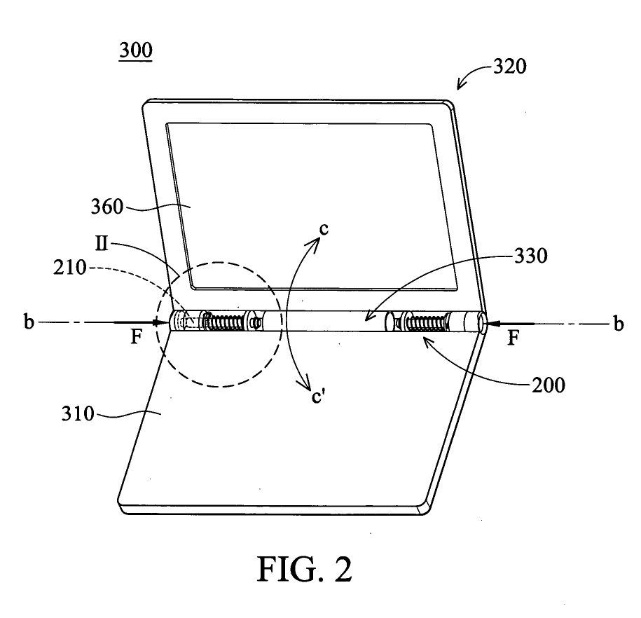

FIG. 2 is a schematic view of notebook computer 300 according to the present invention with display 360 in an opened position. The present invention utilizes a hinge 330 with a rotating and positioning mechanism 200 therein as an engaging device to secure the display 360 in a closed position. To bring the display 360 to the open position, a force F is applied on both sides of the rotating and positioning mechanism 200, releasing the display 360 from closed position. The notebook computer 100 is completely opened by rotating the display 360 in the direction indicated by arrow C in FIG. 2. A detailed description of the notebook computer and the rotating and positioning mechanism is provided in the following.

The hinge 330 is disposed on the first body 310 of the notebook computer 300. The hinge 330 is long enough, in this embodiment, such that the hinge 330 has a sliding member 210 therein, as one of the major engaging elements. The second body 320 has a display 360, movably disposed on the hinge 330 along a rotational shaft in direction b so that the second body 320 rotates with respect to the first body 310. The rotational path of the second body is shown by arrow c-c′. The rotating and positioning mechanism mentioned above can be disposed on one or both sides of the notebook computer 300. The notebook computer 300 may have on or to sets of rotating and positioning mechanisms based on design requirements. It should be noted however that one set is sufficient.

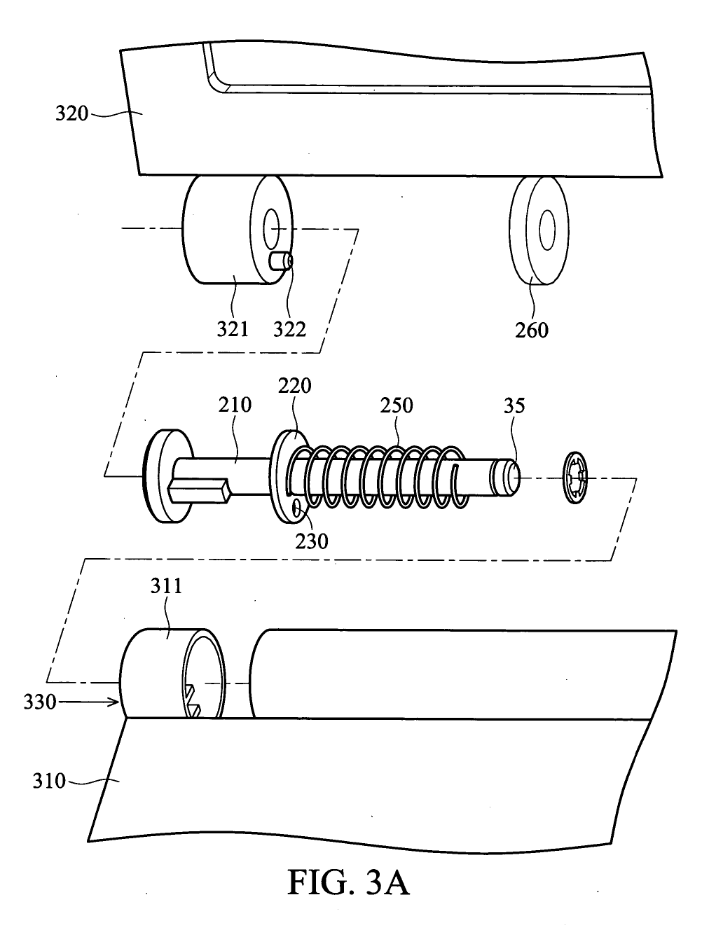

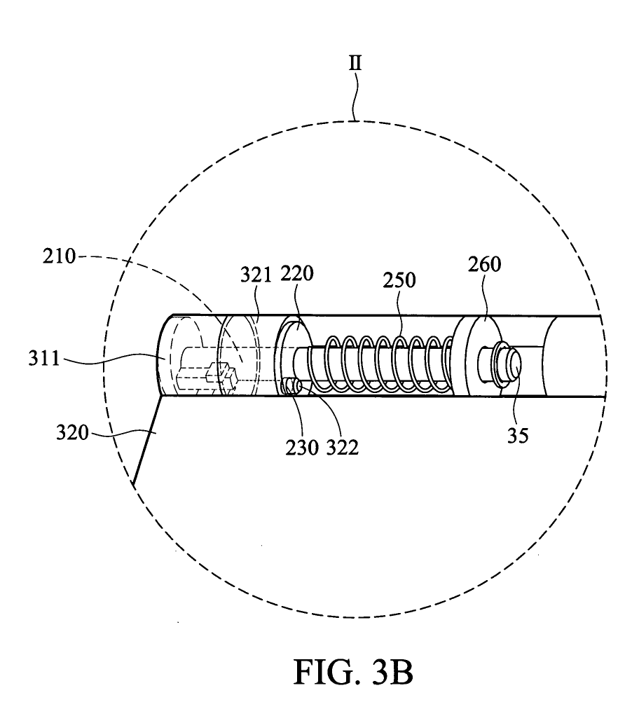

FIGS. 3A and 3B are local exploded and enlarged views of FIG. 2 along arrow c′ when the display 360 in a closed position. The first body 310 has a first sleeve 311, and the second body 320 has a second sleeve 321. A part of the sliding member 210 passes through the first sleeve 311 and the second sleeve 321. The sliding member 210 has a first board 220 with a hole 230 defined thereon. The second sleeve 321 has a protrusion 322. When the second body 320 rotates with respect to the first body 310 to a predetermined angle as shown in FIG. 3B, the protrusion 322 is aligned with hole 230 and inserted therein to firmly secure the second body 320 on the first body 310 restricting further rotation. Additionally, although not shown in the figure, the locations of protrusion and hole are interchangeable. That is, the protrusion is disposed on the first board 220, and the hole is defined on the second sleeve 321 so that the protrusion is also aligned with the hole.

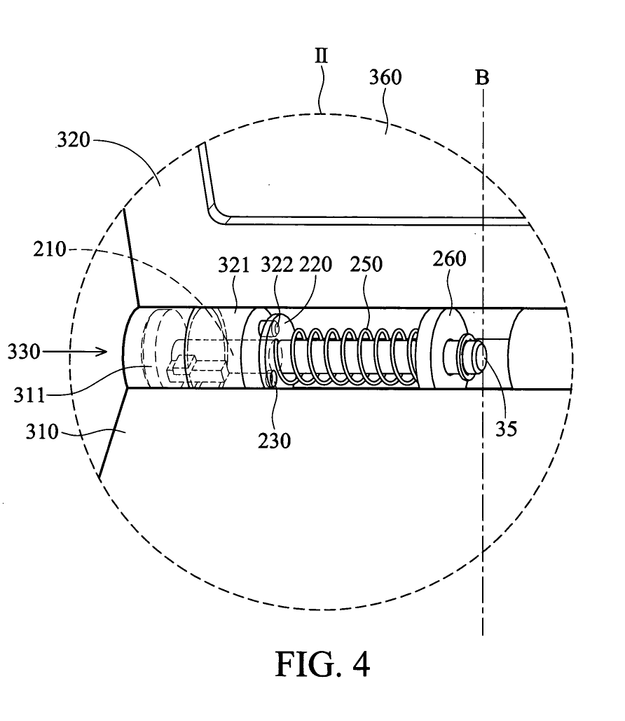

As shown in FIG. 4, the above described engagement can be released by pressing the sliding member 210 to allow the sliding member 210 move along the hinge 330 so that the protrusion 322 is separated from the hole 230. For example, when the sliding member 210 moves a certain distance or moves to a predetermined location B, the second body 320 can then rotate with respect to the first body 310. Moreover, either the first or second body 310, 320 has a second board 260 disposed thereon. In this embodiment, the second board 260 is disposed on the second body 320, as shown in FIG. 3A or 3B. An elastic member such as a spring 250 around the sliding member 210, is disposed between the first board 220 and the second board 260. The spring 250 allows the sliding member 210 to move back and forth on the first body 310. Moreover, when the second body 320 rotates to a predetermined angle, the spring 250 exerts compressive force on the first board 220 so that protrusion 322 is inserted into hole 230. In addition, an end of the protrusion 322 has a beveled edge to facilitate insertion into the hole 230. For convenient installation, a C-shaped or E-shaped ring 350 is disposed on an end of the sliding member 210 to prevent separation of the sliding member 210 from the first and second sleeves 311, 321.

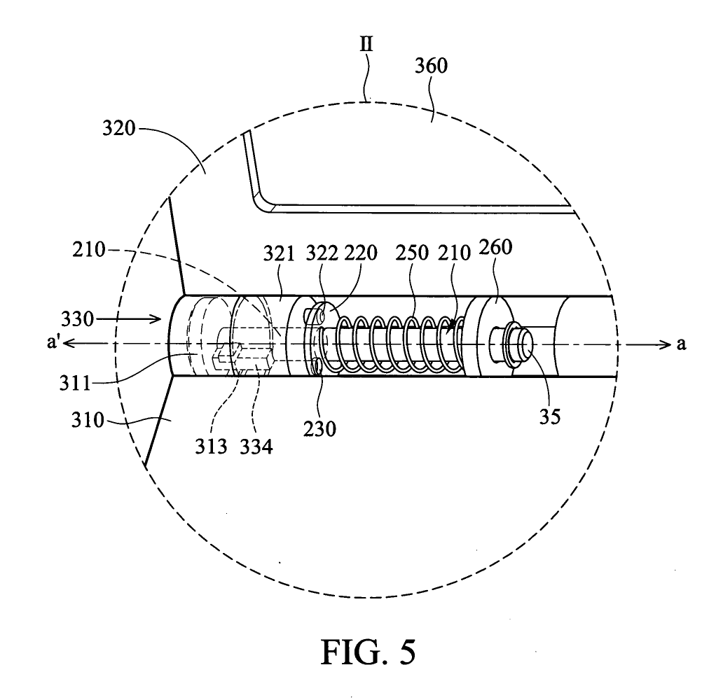

As shown in FIG. 5, the first sleeve 311 of the first body 310 has a guiding passage 313 disposed therein. A sliding block 334 is disposed on the sliding member 210 and is movable along the guiding passage 313. As a result, movement of the sliding member 210 is constrained along the direction a-a′ on the rotational shaft, and the sliding member 210 does not rotate with the second body 320. Although not shown in the figure, the locations of the sliding block and the guiding passage are interchangeable. The guiding passage is disposed on the sliding member 210, and the sliding block is disposed on the first sleeve 311.

The notebook computer of the present invention utilizes the rotating and positioning mechanism as an internal engaging device. The conventional, external locking device is replaced by the rotating and positioning mechanism of the present invention so that the appearance of the notebook computer is not restricted by the engaging device and the engagement is easily released to open the notebook computer by pressing the sliding member of the rotating and positioning mechanism.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A rotating and positioning mechanism, comprising:
a first body;
a second body having a rotational shaft, rotatably disposed along the rotational shaft with respect to the first body; and
a sliding member, slidably disposed on the rotational shaft and disposed in the first body; when the second body rotates to a predetermined angle, the sliding member engages the second body, thereby securing the second body to the first body.

2. The rotating and positioning mechanism as claimed in claim 1, wherein the first body has a first sleeve, and the second body further has a second sleeve, the sliding member is disposed in the first and second sleeves.

3. The rotating and positioning mechanism as claimed in claim 1, wherein the second body further has a protrusion, and the sliding member has a hole; when the second body rotates to a predetermined angle, the protrusion is inserted in the hole.

4. The rotating and positioning mechanism as claimed in claim 1, wherein the second body further has a hole, and the sliding member has a protrusion; when the second body rotates at the predetermined angle, the protrusion is inserted in the hole.

5. The rotating and positioning mechanism as claimed in claim 1, further comprising an elastic member, the elastic member pushes the sliding member to engage the sliding member with the second body.

6. The rotating and positioning mechanism as claimed in claim 1, wherein the first body further has a guiding passage along the rotational shaft, and the sliding member has a sliding block, disposed in the guiding passage.

7. The rotating and positioning mechanism as claimed in claim 1, wherein the first body further has a sliding block disposed along the rotational shaft, and the sliding member has a guiding passage, wherein the sliding block is disposed in the guiding passage.

8. A portable device, comprising:
a first body;
a hinge;
a second body, connected to the first body by the hinge, having a display and a rotational shaft, wherein the second body is rotatably disposed along the rotational shaft with respect to the first body; and
a sliding member, movably disposed on the hinge;
when the second body rotates to a predetermined angle, the sliding member engages the second body, thereby securing the second body to the first body.

9. The portable device as claimed in claim 8, wherein the first body has a first sleeve, and the second body further has a second sleeve, the sliding member is disposed in the first and second sleeves.

10. The portable device as claimed in claim 8, wherein the second body further has a protrusion, and the sliding member has a hole; when the second body rotates to a predetermined angle, the protrusion is inserted in the hole.

11. The portable device as claimed in claim 10, wherein the protrusion has a beveled end.

12. The portable device as claimed in claim 8, wherein the second body further has a hole, and the sliding member has a protrusion; when the second body rotates to a predetermined angle, the protrusion is inserted in the hole.

13. The portable device as claimed in claim 12, wherein the protrusion has a beveled end.

14. The portable device as claimed in claim 8, further comprising an elastic member, the elastic member pushes the sliding member to engage the sliding member with the second body.

15. The portable device as claimed in claim 14, wherein the elastic member is a spring.

16. The portable device as claimed in claim 8, wherein the first body further has a guiding passage along the rotational shaft, and the sliding member has a sliding block, disposed in the guiding passage.

17. The portable device as claimed in claim 8, wherein the first body further has a sliding block disposed along the rotational shaft, and the sliding member has a guiding passage, wherein the sliding block is disposed in the guiding passage.

18. The portable device as claimed in claim 8, further comprising an E-shaped ring, disposed on an end of the sliding member.

19. The portable device as claimed in claim 8, further comprising a C-shaped ring, disposed on an end of the sliding member.
